(19) United States
(12) Patent Application Publication
(10) Pub. No.: US 2014/0200144 A1
(43) Pub. Date: Jul. 17, 2014

(54) TREATMENT OF CROPS WITH A LOWER ALKYL NAPHTHALENE TO ALTER CELL CYCLE AND WATER REGULATION

(71) Applicant: 1,4 GROUP, INC., Meridian, ID (US)

(72) Inventors: Michael Campbell, North East, PA (US); Addie Waxman, Meridian, ID (US); James Zalewski, Boise, ID (US)

(73) Assignee: 1,4 GROUP, INC., Meridian, ID (US)

(21) Appl. No.: 13/743,280

(22) Filed: Jan. 16, 2013

(51) Int. Cl. A01N 27/00

(52) U.S. Cl. CPC A01N 27/00
USPC 504/357

(57) ABSTRACT

The instant invention relates to identification of certain genes in potatoes, which are activated by treatment of said potatoes with a preselected dosage of a lower alkyl naphthalene, especially 1,4 dimethyl naphthalene. The activation of these genes produces a dormancy-like state in said potatoes. Particular embodiments relate to the identification of dehydration-resistant genes in said potatoes, which were also activated by said treatment with a lower alkyl naphthalene, such as 1,4 dimethyl naphthalene.

### BACKGROUND OF INVENTION

Potato is the fourth largest agricultural commodity on the world market and a sizable portion of the yearly harvest is placed in storage. Prolongation of the storage of harvested potato tubers is predicated on the ability to prevent sprouting of tuber meristems. Premature sprouting results in conversion of stored starch to sugars, resulting in plant material unsuitable for either the fresh market or for processing. Thus, suppression of sprouting is key to the maintenance of the potato harvest for commercial purposes. After harvest, potato tubers enter a state of endodormancy. This natural process of endodormancy is a quantitative trait, controlled by a suite of genes, which results in variability in the length of the dormant between potato cultivars, and at times between different harvests of the same cultivar. The onset and duration of endodormancy in potato is linked to abscisic acid (ABA) and ethylene levels in tuber tissue. Genetic analysis has previously shown that genes linked to increased ABA levels prolong the endodormant state and that changes in genes controlling ABA metabolism are altered as dormancy terminates.

Transcriptional profiling, using oligo arrays developed for potato, has been previously used to ascertain gene responses during tuber initiation and in reactivated meristems following treatment with the phytohormones cytokinin and gibberellin. cDNA microarrays have been used to demonstrate transcriptional changes in potato tubers meristems in response to dormancy status.

The application of a growth inhibitor such as chlorpropham (CIPC) is often used to prevent premature sprouting following the termination of endodormancy during storage. CIPC is known to disrupt mitotic spindle formation in dividing cells and it has a long-history of use as a sprout control agent on stored potatoes (Vaughn and Lehnen 1991). In 1996, the EPA reregistered CIPC and reduced the allowable amounts of CIPC residue on potato tubers from 50 ppm to 30 ppm (Environmental Protection Agency, 1996). CIPC is not used on seed potatoes, as its effects are irreversible and will prevent the sprouting of seed stock. Thus, there is interest in finding new methods or compounds that can be used to control premature sprouting in stored potato tubers. The naturally occurring compound 1,4-dimethylnaphthalene (DMN) was isolated from potato tubers and was shown to prevent premature sprouting (Beveridge et al. 1981). DMN has demonstrated the ability to reversibly prevent sprouting, making it attractive as a sprout inhibitor on seed tubers (Pinhero et al. 2009). The mode of action of DMN is unknown but recent experiments have determined that CIPC and DMN do not function through a similar mechanism of action and neither sprout inhibitor functions by prolongation of innate dormancy (Campbell et al. 2010).

Treatment of potatoes with 1,4 dimethyl naphthalene is described in the following U.S. Pat. Nos. 6,010,728; 6,541,054; 5,918,537; 6,338,296 and 6,403,536; all to Forsythe et al.

### SUMMARY OF INVENTION

A particular embodiment relates to a method of maintaining hydration in crops, plants, or produce containing osmotin-expressing genes, which includes treating the crop, plant, or produce in a post-harvested state with an effective dosage of a lower alkyl naphthalene sufficient to turn-on the osmotin-expressing genes.

Another embodiment relates to a method of maintaining hydration of a plant (or product of said plant) that includes treatment of said plant or product thereof with an effective dosage of a lower alkyl naphthalene, wherein the plant has at least one identified gene.

Yet another embodiment is drawn to a method of maintaining hydration in a post-harvested, plant product, which method includes treating the plant product in a hydrated state with an effective dosage of a lower alkyl naphthalene.

An alternative embodiment is drawn to a method of treating plant bulbs to minimize premature sprouting in the same. The method includes treating the bulbs with an effective amount of a lower alkyl naphthalene sufficient to activate genes associated with endodormancy.

### BRIEF DESCRIPTION OF THE SEVERAL VIEWS OF THE DRAWINGS

In the drawings, in which various features of embodiments of the present invention are depicted:

FIG. 1 is a diagram of the treatment regimes for potato tissues treated with DMN according to a particular embodiment;

FIG. 2 is a Venn diagram showing transcript changes between meristems isolated from various treated and control groups of tubers;

FIG. 3 is a QT-PCR analysis of potato meristem transcripts isolated from potatoes treated with DMN; and

FIG. 4 is a schematic illustrating a possible mechanism for KRP1 and KRP2 in cell cycle repression following DMN exposure.

### DETAILED DESCRIPTION

The instant disclosure relates to identification of certain genes in potatoes, which are activated by treatment of said potatoes with a preselected dosage of a lower alkyl naphthalene, especially 1,4 dimethyl naphthalene. The activation of these genes produces a dormancy-like state in said potatoes.

Of further interest was the identification of dehydration-resistant genes in said potatoes, which were also activated by said treatment with a lower alkyl naphthalene, especially 1,4 dimethyl naphthalene. This latter discovery is significant in its application to plants other than potatoes and products thereof via the relationship of all such plants to Arabidopsis thaliana, as elucidated by the experimental work described hereinafter.

The identification of up-regulated genes associated with dormancy extension provides a useful technique in extending dormancy of various plants and produce containing said genes by treatment with a lower alkyl naphthalene. Such plants and produce may include those intended for human or animal consumption, but also to others such as iris bulbs, tulip bulbs, gladiola bulbs, and other flowering plants such as daffodils, hyacinths and the like which are grown from bulbs. It is desirable that iris bulbs, tulip bulbs and the like do not prematurely sprout during storage and/or shipment. The advantage of treatment with 1,4 DMN, e.g., is that it does not adversely affect the later sprouting and plant growth from such treated bulbs.

Root vegetables, such as carrots, radishes, turnips, beets, rutabaga, onions, shallots, and the like, contain the same genes, which are up-regulated in potatoes treated with 1,4 DMN, for example. Thus, if so desired, treatment of such root vegetables in accordance with the techniques of the instant invention will extend the period of dormancy. A further advantage of such treatment is that resistance to desiccation will be improved by up-regulation of genes associated with water retention and drought assistance.

Numerous plants and fresh produce thereof raised for human consumption quickly dehydrate and become inedible shortly after harvest. The identification of moisture-retaining genes activated by lower alkyl naphthalenes, especially 1,4 DMN, provides a treatment mechanism for extending the preservation of edible lifetime of said plants and produce.

Potato tubers were treated with DMN. Transcriptional profiling, via oligo array analysis, was used to determine genes that exhibit altered expression in response to DMN.

Field-grown certified Russet Burbank seed tubers were obtained from a commercial grower shortly after harvest. The tubers were allowed to wound-heal for two weeks at room temperature in the dark. The tubers were then transferred to cold (3-4° C.) storage. The tubers were periodically evaluated for dormancy status. Only non-dormant tubers (100% sprouting after two weeks at 20° C.) were treated with 1,4 DMN.

Transcriptional profiling, using oligo arrays developed for potato, has been used to examine changes in gene expression during tuber initiation (Kloosterman, et al. 2008) and in reactivated meristems following treatment with the phytohormones cytokinin and gibberellin (Hartmann, et al. 2011). cDNA microarrays have been used to demonstrate transcriptional changes in potato tubers meristems in response to dormancy status (Campbell et al. 2008). In this study, potato tubers were treated with DMN and transcriptional profiling, via oligo array analysis, was used to identify genes that exhibit altered expression in response to DMN.

DMN was shown to be effective on sprouting root and tuber crops, including but not limited to, beet, carrot, cassaca, dasheen (taro), ginger, ginseng, horseradish, parsnip, pototato, sweet potato, turnip, and yam. DMN was also shown to be effective on sprouting bulb crops, including but not limited to, garlic, leek, onion, and shallot. DMN was also shown to be effective on sprouting ornamentals, such as flowering bulbs.

### Experimental Methods

### Plant Material

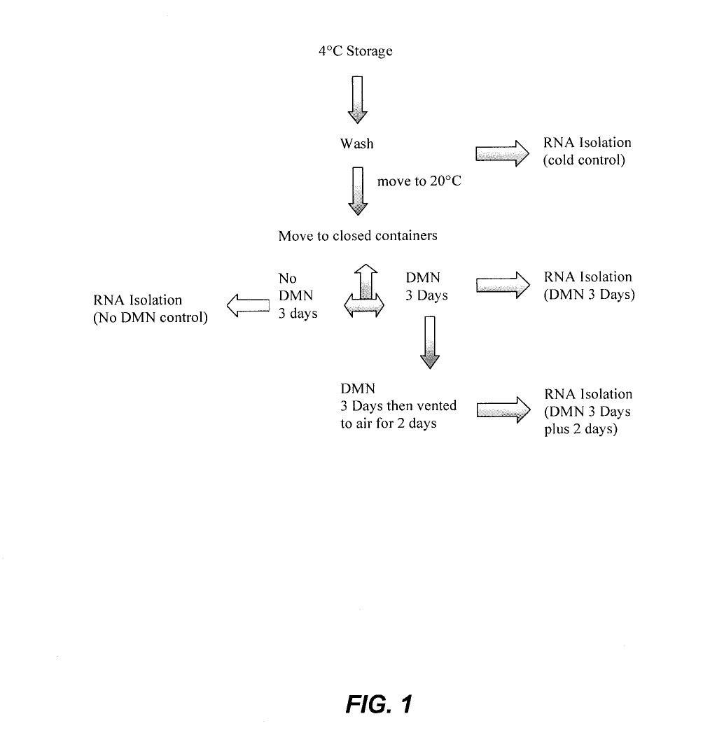

Field-grown certified Russet Burbank seed tubers were obtained from a commercial grower shortly after harvest. The tubers were allowed to wound-heal for two weeks at room temperature in the dark. The tubers were transferred to cold (3-4° C.) storage. The tubers were periodically evaluated for dormancy status. Only non-dormant tubers (100% sprouting after two weeks at 20° C.) were used in these studies. Thus, the dormancy status of these meristems can be considered to be ecodormant and held in the growth arrested state due to low temperatures. A diagram of the experimental design is found in FIG. 1.

### DMN Treatment

On the day of treatment, tubers were transferred from 3° to 20° C. and were immediately washed in running tap water. After drying at room temperature in the dark, the tubers were placed into 4 L airtight containers. A beaker containing about 5 g of activated charcoal was placed in the chamber containing the control tubers prior to sealing (Control). DMN (0.15 mL liquid) was placed on cotton wool in a beaker and sealed in the treatment chamber (DMN3 days). The chambers were incubated in the dark at 20° C. for three days. At this time tubers were removed and the lateral meristems were isolated using a curette with the aid of a dissecting microscope. Either used fresh (thymidine incorporation) or immediately frozen in liquid nitrogen and stored at −80° C., as previously described (Campbell et al., 1996). One group of DMN-treated tubers was incubated for a further two days in air (dark, 20° C.) prior to meristem isolation (DMN3 days+2). Samples were also collected from untreated non-dormant buds at day 0 immediately after removal from 3° C. storage; henceforth referred to as eco-dormant (Lang et al. 1987)

### Thymidine Incorporation

Freshly excised meristems were washed with deionized water and groups of 20 buds were incubated on 1 mL of buffer (10 mM Mes/KOH; pH 5.7) containing 0.9 μCi of ³H-thymidine (60 μCi/μmole; American Radiolabeled Chemicals Inc., St. Louis, Mo.). The meristems were incubated on an oscillating shaker (100 rpm) at room temperature in the dark. After three hours, meristems were removed from the incubation media, washed extensively with deionized water followed by two washes with incubation buffer containing 5 mM unlabeled thymidine, blotted dry, frozen in liquid nitrogen, and stored at −80° C. To determine incorporation, the frozen meristems were homogenized in 1 mL ice-cold 10% (w/v) TCA. After standing on ice for 3-4 hours, the samples were vigorously mixed. An aliquot was removed and placed in a scintillation vial to determine total uptake. A second equal aliquot was removed and placed on a microfiber filter (GF/C; Whatman). The filter was sequentially washed under vacuum with 2×20 ml 5% (w/v) TCA and 20 ml 95% (v/v) ethanol (both at 4° C.). The washed filter was then placed in a scintillation vial to determine total incorporation into TCA-precipitable material (DNA).

### RNA Isolation

RNA was isolated from frozen meristems by grinding to a fine powder in a mortar and pestle followed by isolation and purification using a Ribopure Kit (www.ambio.com). RNA was quantified using a BioSpec nano and quality was assessed by gel electrophoresis and visualization of ribosomal RNA. Total RNA (500 ng) was denatured in the presence of a T7 promoter primer and cDNA was synthesized using reverse transcriptase. The cDNA was used as a template for in vitro transcription by synthesis with T7RNA polymerase, which amplified target material and incorporated cyanine 3-labeled CTP. The labeled cRNA was purified using spin columns and quantified using a spectrophotometer. A sample of 1.65 μg of cyanine 3-labeled linearly amplified cRNA was hybridized to an Agilent 44K 60-mer-oligo microarray that was developed by the Potato Oligo Chip Initiative (POCI) (Kloosterman et al. 2008). Probe generation and hybridization to the array were conducted through a contract to Gene Logic (www.genelogic.com). Twelve samples were used to probe against the POCI array, three samples from eco-dormant meristems (harvested directly from 3° C. storage), three samples from meristems isolated from tubers treated with DMN for three days in a closed container, three samples treated with water for three days in a closed container, three samples treated with DMN for three days and then exposed to air for two days. The three samples for each treatment were biological replicates.

### Microarray Analysis

Analysis of the microarray was conducted in two stages; total array data was examined using a linear model and the software limma, and pathway analysis was conducted by linking the potato sequences to the Arabidopsis thaliana. Analysis of the entire microarray data set was accomplished using R and the limma package (Smyth 2005), or GeneMaths XT (Applied Maths, Inc.). The data was corrected for background and normalized between arrays using a loess method. Comparisons between treatments was established using an empirical Bayes method (Smyth 2004). The use of limma for analysis of oligo arrays was accomplished by analyzing data from a single emission channel.

Pathway analysis was accomplished by using tBLASTx (Altschul et al. 1990) to search the A. thaliana genome for homologs. Transcripts that exhibited an e-value of less than 1.0e-5 were assigned a function according to the described function for the A. thaliana homolog. The array data was transformed to log base 2 and normalized between arrays using default parameters in GeneMathsXT software package (www.applied-maths.com). Probes had to have hybridization intensities of at least 2 standard deviations greater than background in one or more treatments to be included in the dataset. Pathway Studio 8.0 (www.ariadnegenomics.com) was utilized to determine metabolic changes that were associated with DMN treated for three days compared to controls.

### QT-PCR

A set of transcripts was selected for further analysis to confirm the microarray data and to determine the possible cell cycle position of tubers treated with DMN. Gene names and primers sequences used for QT-PCR are found in Table 1. The oligo nucleotide sequences spotted on the array were too short for adequate primer design. Therefore, primers were determined by isolating a longer DNA sequence from the DFCI-Potato Gene Index corresponding to the microarray oligonucleotide and searching that sequence for primers using the Applied Biosystems Primer Express 3.0 software (www.appliedbiosystems.com). cDNA template for QT-PCR was prepared from mRNA isolated from potato meristems treated with DMN for three days as described above. PCR reactions were run on a StepOne™ Real Time System and analyzed using Step One Software v2.0 (www.appliedbiosystems.com) to determine ΔΔCT values on a log₁₀ scale. Three biological replicates and three technical replicates were analyzed for each sample. Primers amplifying ACTIN2 (TC133139) homologs were used as internal controls and to normalize across reactions. ACTIN2 were chosen as controls because expression was relatively constant across all arrays.

### Results

³H-thymidine incorporation was used to determine the effects of DMN treatment on cell division. In meristems isolated from tubers incubated at 20° C. for three days, between 12.5 and 14.3% of the labeled thymidine taken up was incorporated into DNA while in meristems isolated from DMN-treated tubers, thymidine incorporation was reduced to 6.5 to 6.7% of the label taken up (Table 1). The level of thymidine incorporation after DMN exposure (under 10%) was similar to the levels previously reported for endodormant potato meristems (Campbell et al. 1996).

Microarray analysis: 34444 probes were considered expressed in at least one treatment; of these, 13125 were differentially expressed in at least one treatment (Benjamini Hochberg modified p value <0.005) (Supplemental Table 1). These large numbers of differentially expressed genes suggest major modifications to the transcriptome for all treatments.

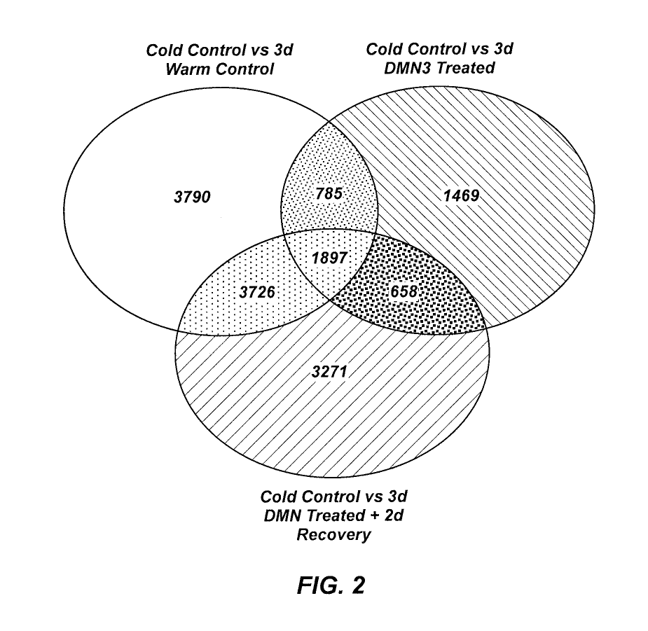

Comparison of gene expression between each treatment and the untreated ecodormant control was visualized using a Venn diagram (FIG. 2). Placing potato tubers in a closed container with or without DMN did result in a small change in meristem transcripts (1897). A total of 1469 oligonucleotides exhibited expression unique to the tissues treated with DMN for 3 days and the number increased to 3271 oligonucleotides being unique to the DMN-treated tissues for 3 days and then vented to the air for two days. This rise in transcripts changing in expression following DMN treatment and then exposure to air suggests an increasing shift in transcriptional profiles as tissues begin to respond to DMN exposure. Placing tubers in closed containers did result in a unique set of transcript changes independent from DMN-induced gene expression.

Pathway analysis highlights the similarities between meristems from eco-dormant and DMN-treated tubers in comparison to meristems incubated at 20° C. for three days. 294 ontologies were associated with genes that are preferentially expressed following incubation at 20° C. compared to eco-dormant tissues, and 251 ontologies were associated with genes that are preferentially expressed following incubation at 20° C. compared to DMN-treated tubers. More than half of the ontologies were common between the comparisons (Supplemental Tables 2, 3). These common ontologies highlight significant changes in the transcriptome associated with cell cycle progression that were generally up-regulated in meristems from tubers allowed to incubate at room temperatures in the enclosed container for 3 days relative to the ecodormant tissues (cold control). This is consistent with the increase in ³H-thymidine incorporation during the same time. Interestingly, these same meristems show similar increases in cell cycle progression when compared to meristems from tubers treated with DMN under the same conditions.

### Confirmation of Differential Gene Regulation by QT-PCR

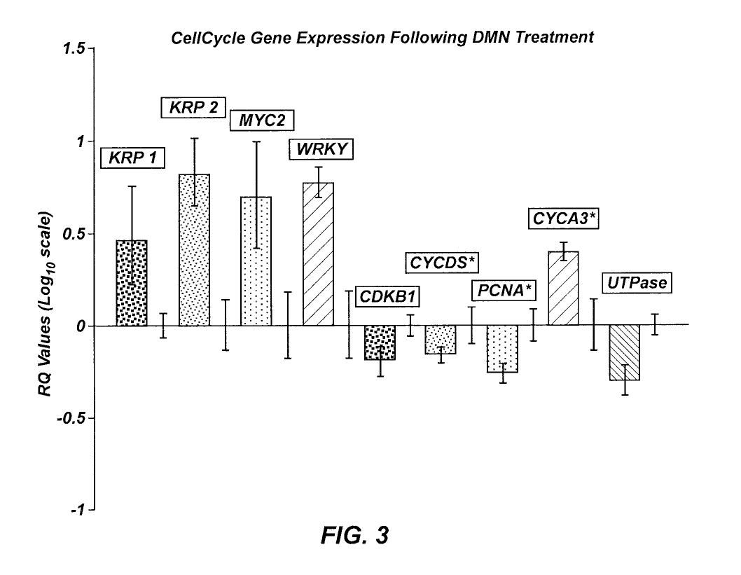

QT-PCR was used to both confirm microarray data and to examine additional transcripts that were either not present on the POCI array or were eliminated from analysis after normalization and removal of systematic errors. The transcripts for CDKB1, CYCD3, PCNA, and UTPase, all of which are associated with G1/S-phase or early S-phase, were decreased following DMN treatment. Transcripts for the cell cycle inhibitor KRP1 and KRP2, which were not present in the microarray data but were implicated as having a role through sub-network analysis, were elevated in tissues treated with DMN, as were transcripts for MYC2, WRKY, and CYCA3 (FIG. 3).

### Discussion

Although the growth-inhibiting properties as well as the commercial utility of DMN have been known and exploited for a number of years, the mechanisms through which DMN exerts its biological effects are currently unknown. Previous research has established that DMN does not exert its sprout inhibiting activities by extending the natural period of tuber endodormancy (Campbell et al., 2010). However, the growth-inhibiting properties of DMN suggest that there is a disruption of cell cycle progression that results in the inhibition of cell division.

In both DMN treated and ecodormant meristems, a large number of transcripts associated with water regulation, salt stress, and osmotic adjustment were preferentially up-regulated relative to what was observed in 20° C. untreated tuber meristems (Table 3). Some of these transcripts have also been associated with stress and/or ABA induction in other plant species (Okamoto, Tatematsu et al. 2010). There were relatively fewer differences among genes associated with these ontologies in meristems from DMN treated tubers compared to the eco-dormant tubers than when ecodormant tubers were compared to tubers incubated at 20° C. without DMN. However, there were still some ontologies associated with cold/drought/osmotic stress that were down-regulated when tubers were moved to 20° C. in the presence of DMN. This is consistent with previous research on potato indicating that DMN treatment did not result in an increase in ABA levels over control tissues (Campbell et al. 2010), and suggests that DMN treatment is at least partially capable of maintaining transcription profiles associated with cold/drought/osmotic stress in the absence of these stresses.

### Cell Cycle Regulation by DMN

The about 50% reduction in thymidine incorporation into DNA in non-dormant tuber meristems following DMN treatment (Table 1), and decreased expression of a large number of transcripts that encode cyclin or cyclin-like proteins (Table 2) strongly implicate a role of DMN in cell cycle progression. It has been shown that tubers exiting endodormancy are arrested in the G1-phase of the cell cycle (Campbell et al. 1996). The suppression by DMN of a diversity of cyclin transcripts, while tubers are in a G1-induced dormancy block, should prevent entry into the S-phase of the cell cycle. Specifically, progression of the cell cycle through a G1/S-phase block has been linked to the expression of the D and E-type cyclins (De Veylder et al. 2003; Doonan and Kitsios 2009), and initiation of meristem growth would require initial expression of the D and E-cyclins for meristem activation. Thus, we hypothesize that DMN maintains cell cycle arrest in the G1/S-phase by directly or indirectly inhibiting transcription of D and E-type cyclins. DMN suppression of transcription for the potato homologs of the cyclins CYCD1, CYCD2, CYCD3 would limit protein components for the CDK/cyclin partners that drive initiation of cell division in potato meristems that result in sprouting (Van Leene et al. 2010).

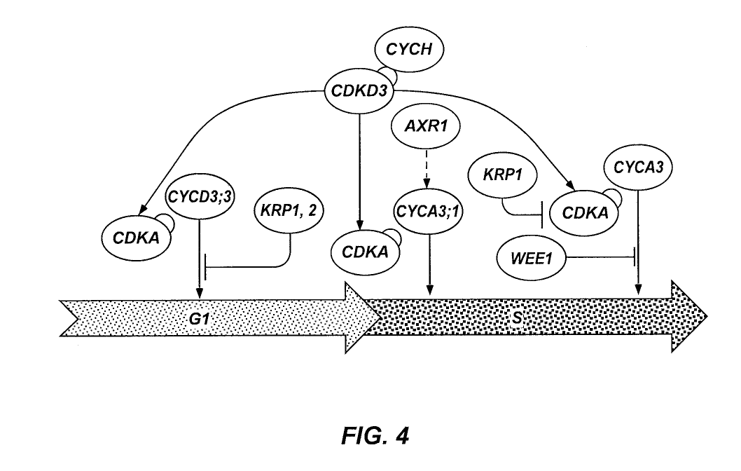

Cell cycle progression is also controlled by cyclin-dependent kinase inhibitors (CKIs)(Inze and De Veylder 2006). In the early G1 phase of the cell cycle, CDKA forms a complex with CYCD3. The activity of this complex is inhibited by the CKIs KRP1 and KRP2, thereby repressing cell cycle advancement (Menges, de Jager et al. 2005). KRP1 and KRP2 were found to have increased expression in tissues treated with DMN (FIG. 3). This up-regulation corresponds with the down-regulation of CYCD3, suggesting that DMN prevents sprouting by inhibiting the formation of the CDKA/CYCD3 complex, thus resulting in a G1 cell cycle block. It has been suggested that CDKB1 indirectly increases the activity of the CDKA/CYCD3 by phosphorylation and inhibition of KRP2 (Verkes et al. 2005). QT-PCR analysis indicates that DMN decreases the transcription of CDKB1, suggesting that the G1 block induced by DMN is also a result of the maintenance of KRP2 inhibition of the CDK/CYCD3 complex. Deoxyuridine triphosphatase (dUTPase) has been shown to be an early marker of dormancy termination prior to entry into the S-phase of the cell cycle (Senning et al. 2010). Exposure to DMN resulted in a decrease of UTPase, which again suggests DMN is maintaining a cell cycle block prior to S-phase. FIG. 4 outlines the interaction of some of the proteins associated with cell cycle regulation. The increased expression of KRP1 and KRP2 suggests two possible positions for cell cycle repression, one in the G1 and the other in the S-phase. The decreased expression of dUTPase suggests that a DMN-induced-block via KRP expression is more likely occurring during G1 because the expression of dUTPase occurs prior to S-phase entry. This hypothesis is also supported by the low levels of thymidine incorporation.

Nucleoside diphosphate kinase (NDPK) is down regulated by exposure to DMN (Table 2). The function of the NDPK protein is to regulate the cellular levels of nucleotides and it is linked to organogenesis in animals (Lakso et al. 1992), cell proliferation (Keim et al. 1992), and response to salt stress in plants (Kawasaki et al. 2001). There is evidence that NDPK expression is directly associated with response to stress and reactive oxygen and the alteration of the mitogen activated protein kinases MPK3 and MPK6 (Moon et al. 2003).

In Saccharomyces cerevisiae, activation of HOG1 by salt stress or high osmoticum results in cell cycle arrest in the G1/S-phase by directly affecting the SIC1 gene product (Escote et al. 2004). In potato, DMN treatment results in the increase of MPK4, 6(Table 1) and KRP1, 2, (FIG. 3) homologues of HOG1 and SIC1, respectively. This suggests that in potato there is a HOG1-like cascade interacting with the G1/S-phase regulators CIP/KRP and this pathway may be a target for sprout control by DMN. Transcripts assigned to water regulation and responses to salt stress were increased following DMN treatments (Table 2). It has been reported that a phenotypic response of potato tubers to DMN exposure is an increase in turgidity and maintenance of tuber fresh weight (J. Zalewsky, personal communication). Interestingly the KRP genes are known to decrease cell number and increase cell size when over-expressed (De Veylder et al. 2001).

DMN exposure also increases the transcription of the MPK genes. In yeast, the gene HOG1 is classified as a member of the mitogen-activated protein kinase (MAPK) family. In yeast and other fungi, HOG1 functions as a MAPK that interacts within the signal transduction cascade linking growth signals to cell division regulation and it also functions in the sensing system for the regulation of osmotic potential (Brewster et al. 1993; Gustin et al. 1998). HOG1 expression results in a shift in transcriptional profiles, which results in a large change in gene expression in response to changes in osmolarity (O'Rourke and Herskowitz 2004). Exposure of potato tubers to DMN results in an increase in a HOG1 homolog. The HOG1 cascade in yeast results in growth suppression by down regulation of the G1/S-phase cyclins Cln1 and Cln2 (Clotet and Posas 2007). A tBLASTx analysis of the Arabidopsis thaliana genome using the Cln1 gene from Saccharomyces cerevisiae finds that the gene CYCA1 is the closest homolog. DMN treatment, which results in elevated expression of the HOG1 homologs MPK4 and MPK6, also results in a decrease in the Cln1 homolog CYCA1. This suggests that DMN growth arrest may be due to a decrease in the G1/S-phase cyclins through the increase activity of MPK4/PK6.

This information translates to many other crops and plants having the same genes wherein treatment with a lower alkyl naphthalene provides similar advantageous results.

Such treatment has been performed with berries and is described in copending U.S. patent application Ser. No. ______ (Attorney Docket No. 1957-P10340US), having a common inventor and commonly assigned, the contents of said application being incorporated herein in its entirety by incorporation by reference.

Berries are a fragile, freshly harvested crop which maintain improved hydration and, ergo, a longer, healthier shelf life when treated with 1,4 DMN, for example.

Other crops which may be similarly enhanced include leafy vegetables, such as lettuce, cabbage, spinach and the like. Other leafy crops such as freshly cut flowers may also be advantageously treated to maintain freshness for a longer period of time.

Other bulb-type crops, such as onions, garlic, tulip, iris, gladiola and the like may be advantageously treated to extend an endodormant-like state to minimize premature sprouting and loss of turgidity.

The commonality of all of these crops resides in the presence of the same or similar genes related to endodormancy and/or drought resistance. The presence of such genes in both potato and it's evolutionary progenitor, Arabidopsis thaliana, implies that most or all higher plant species, also evolutionary relatives of Arabidopsis, would contain similar genes based on the widely accepted biological principle of evolutionary conservation of genes. This further implies that many/most other plant species would respond similarly to exposure to lower alkyl napthalenes. In some instances, both types of genes are present and in other crops the presence of one group or the other may be less important for the intended result by treatment with a lower alkyl naphthalene.

Genes associated with endodormancy include those identified in Table 2 hereof. Genes associated with drought resistance include those identified in Table 3 hereof.

A further advantage of the instant invention is that the effect of lower alkyl naphthalenes on the above-identified genes persists for a period of time after the chemical is no longer detectable by sophisticated chemical analysis. Thus, such chemicals are largely absent from treated edible plants on crops at the time of human consumption.

TABLE 1
TABLE 1: Thymidine Incorporation. Control and DMN-treated
potato meristems were incubated with ³H-thymidine

| | Control | DMN |
|---|---|---|
| Run 1 | 14.3 ± 2.1% | 6.7 ± 0.4% |
| Run 2 | 12.5 ± 0.2% | 6.5 ± 1.0% |

TABLE 2: Arabidopsis genes orthologous to the potato transcripts that increase in response to DMN treatment. The genes listed are a subset of up-regulated transcripts and represent those that encode for proteins that function in water regulation, response to salt and water stress.

TABLE 2
Transcripts that encode for proteins associated with cell division
and replication that are down-regulated in meristems isolated from
tubers treated with DMN for three days compared to a three-day control.
The following were assigned function based on sequence similarity to
the A. thaliana proteome following tblastx analysis.

DNA replication initiation:
AT2G07690, F16F14.6, AT5G44635, T12C22.19, MCM10, MCM8,
MPL12.6, CDC45, PRL
Regulation of cell cycle:
CDC48B, RCY1, ATZW10, CYCP4;1, AT3G11450, AT3G51670,
AT3G53230, CYCP3;2, T8A17.90, T32A16.110, F7J8.210, F12E4.70,
K15N18.10, PATL2, T518.14, CYCA3;4, HXK3, T9N14.8, CYCB2;4,
CYCA2;4, CYCB2;3, FZR3, ELC, APC8, WEE1, CYCB1;1, HUB1,
CYCD3;1, CCS52A2, TPS1, ARF16, CYCT1;5, CKS1, FZR2 ACT7,
CDC45, LIG1, SYP111, PHB3, DRP3A, SYN2, CYCD3;2, CYCD2;1,
CYCT1;4, ATMINE1, ADL1E, VIMI, CYCA2;3, CYCD3;3, CYC1BAT,
KEU, GRP23, ADL1C, TOZ, CAK1AT, CDKD1;3, AT3G10220,
CYCD1;1, GRV2, CYCH;1, QQT2, QQT1, SMC2, ATSMC3, CYCA1;1,
ATK3
Mitosis:
T26B15.15, ATZW10, YLS8, MIS12, FZR3, WEE1, CDC2, CYCD3;1,
CCS52A2, FZR2, SYN2, CLASP, CYC1BAT, SMC2, ATSMC3, ATK3
Regulation of cell proliferation:
T16E15.11, T12C22.19, ANT, CYCD3;1, ADA2B, CYCD3;2, CYCD3;3,
SDD1
Cell proliferation:
F11C10.33, T15N1.10, ATPSK3, UBC19, 0L12, GIF3, FAS1, ATHB-2,
PKL, ARP6, FAS2, MSI1, NRP2, ELO1, DDL, ABO1, UBP15, ELO3,
RPL5A
DNA unwinding during replication:
AT2G07690, F16F14.6, F22D22.25, F8F16.30, AT5G44635, T12C22.19,
TOP1BETA, MPL12.6, PRL
Cyclin-dependent protein kinase regulator activity:
RCY1, CYCA3;4, CYCB2;4, CYCA2;4, CYCB2;3, CYCB1;1, CYCD3;1,
CKS1, CYCD2;1, CYCA2;3, CYC1BAT, CYCD1;1, CYCA1;1
Cyclin-dependent protein kinase activity:
CYCP4;1, CYCP3;2, K15N18.10, CDKB2;2, CDC2, CDT1A, CDKC;1,
CYCT1;5, CKS1, CYCD3;2, CYCT1;4, CDKB1;2, CYCD3;3, CAKIAT,
CDKD1;3, CDKD1;1, CYCH;1

TABLE 3: Arabidopsis genes orthologous to the potato transcripts that decrease in response to DMN treatment. The genes listed are a subset of down-regulated transcripts and represent those that encode for proteins that function in cell cycle regulation, DNA replication, and cell proliferation.

TABLE 3
Transcripts that encode for proteins associated with water regulation
that are up-regulated in meristems isolated from tubers treated
with DMN for three days compared to a three-day control. The following
were assigned function based on sequence similarity to the A. thaliana
proteome following tblastx analysis.

Response to water deprivation:
PIP2B, T8P21.32, F18C1.3, AT3G06760, PIP1;4, ANNAT7, F2P16.10,
SIP1, MNC17.13, F24B9.8, T24D18.16, ANN5, ATHVA22A, HIS1-3,
RD19, GSTF10, PIPIC RAP2.4, GOLS2, MYB96, HVA22E, DREB1A,
SNRK2.3, CRY1, ABA1, NRT1.1, ABA2, WOL, AHK3, EDR1, STZ,
P5CS1, RGS1, NCED3, CBL1, WRKY33, RD26, COR47, HRB1, ERF7,
PP2CA, ATHB-7, ANACO55, ANNAT1, ABF3, OCP3, AXR1, CIPK23,
LTI65, ATHB-12, ABF4, ABF2, MBF1C, NF-YA5, OST1, MAX2,
SDIR1, PUB23, CCD1, AHK2, RD21, ANNAT4, RCD1, IRX1, PHS2,
NLP7, RD28, SIP3, AVP1, PGR5, PGGT-I, ERD15, AHA1, DRIP2,
FTA, HSP81-2, LTP3, BAM1, MU010.17, LEW1
Response to salt stress:
STZ, MKK2, MEKK1, EIN2, P5CS1, ATNFXL1, ABA3, CBL1, MPK6,
WRKY33, STO, GDH1, GAI, XERICO, MKK9, TPI, MPK4, GSTF8,
CCR2, DDF1, ANNAT1, CCH, ABF3, ADC2, LTI65, SOS2, ATHB-12,
ABF4, ABF2, OST1, RD22, SDIR1, MYB15, ADC1, AHK2, ATHB-1,
GPX6, ANNAT4, HHP1, VPS34, RGL1, ATMRP5, RCD1, PDIL1-1,
RGP1, MKP1, F25P22.8, CHIP, CPK32, MYB32, RHA2A, PAB2,
SIP3, AVP1, COB, TAG1, GAPC1, CPL4, CIPK1, S6K2, HSP81-2,
TRB1, CIMS, T12M4.8, GLY3, PMM, ATCOAD, GT72B1
Cellular response to water deprivation:
BPM2, ATBPM4, MZF18.2, COR414-TM1, SAG21, GSTU19
Response to water desiccation:
RD2, F6E13.19, T3F17.21, AT3G44380, ALDH3H1, RD19, LEA14,
ALDH7B4, P5CS1 MYC2, RD22, RCI3, RD28
Water channel activity:
PIP2;8, PIP2B, PIP2;5, PIP1;4, PIP1;5, PIP1C, TIP2;2, TIP4;1,
GAMMA-TIP, TIP1;3, NIP5;1, RD28, DELTA-TIP, SIP1A, NIP1;2

1. A method of maintaining hydration in crops, plants or produce containing osmotin-expressing genes comprising treating said crop, plant or produce in a post-harvested state with an effective dosage of a lower alkyl naphthalene sufficient to turn-on said osmotin-expressing genes.

2. The method of claim 1, wherein said alkyl naphthalene is a dimethyl naphthalene (DMN).

3. The method of claim 2 wherein said DMN is 1,4 DMN.

4. The method of claim 1, wherein said alkyl naphthalene is in a vapor state.

5. A method of maintaining hydration of a plant (or product of said plant) comprising treatment of said plant or product thereof with an effective dosage of a lower alkyl naphthalene wherein said plant has at least one gene selected from the following class set forth in Table 3 hereof.

6. The method of claim 5, wherein said lower alkyl naphthalene is 1,4 DMN.

7. The method of claim 5, wherein a plurality of said genes is present in said plant or product thereof.

8. A method of maintaining hydration in a post-harvested, plant product comprising treating said product in a hydrated state with an effective dosage of a lower alkyl naphthalene.

9. The method of claim 9, wherein said lower alkyl naphthalene is 1,4 DMN.

10. A method of treating plant bulbs to minimize premature sprouting comprising treating said bulbs with an effective amount of a lower alkyl naphthalene sufficient to activate genes associated with endodormancy.
